(19) United States
(12) Patent Application Publication
(10) Pub. No.: US 2026/0250511 A1
(43) Pub. Date: Aug. 27, 2026

(54) ASPHALT COMPOSITION

(71) Applicant: KAO CORPORATION, Tokyo (JP)

(72) Inventors: Mohand MELBOUCI, High Point, NC (US); Machiko IE, High Point, NC (US); Yusuke AKINO, Wakayama-shi, Wakayama (JP); Eiji SHIRAI, Wakayama-shi, Wakayama (JP)

(73) Assignee: KAO CORPORATION, Tokyo (JP)

(21) Appl. No.: 18/993,036

(22) PCT Filed: Aug. 30, 2022
(86) PCT No.: PCT/US2022/041976

§ 371 Date: Jan. 10, 2025

(51) Int. Cl. C08L 95/00; C08K 5/1539

(52) U.S. Cl. CPC C08L 95/00; C08K 5/1539

(57) ABSTRACT

The present invention relates to an asphalt composition containing an asphalt and a polyester resin composition, wherein the polyester resin composition contains a polyester resin and a hydrocarbon-based compound (i). The polyester resin has a structural unit derived from an alcohol component and a structural unit derived from a carboxylic acid component, wherein the carboxylic acid component contains at least one succinic acid compound selected from the group consisting of an alkylsuccinic acid and an alkenylsuccinic acid. The polyester resin composition has a glass transition point comprised between −70° C. and 30° C. and is present in the asphalt composition in an amount of ≥0.5 parts by mass and ≤25 parts by mass relative to 100 parts by mass of the asphalt.

### FIELD OF THE INVENTION

The present invention relates to an asphalt composition.

### BACKGROUND OF THE INVENTION

For paving automobile roads, car parking spaces, freight yards, sidewalks, and the like, asphalt pavement using an asphalt mixture is applied to conveniently lay down a pavement, while minimizing the transit service disturbance and duration of the pavement work. from the start The asphalt pavement forms a road surface including an asphalt mixture containing aggregates bound by asphalt, hence providing the paved road with appropriate hardness and durability.

PTL 1 (JP 2021-076005 A) discloses, an asphalt composition that is characterized by a superior rutting resistance of the paved surface id down and a high peeling resistance, particularly under alkaline conditions. The asphalt composition contains asphalt and a polyester resin, wherein the polyester has a structural unit derived from a carboxylic acid component containing at least one acid, selected from alkylsuccinic acid and an alkenylsuccinic acid.

### SUMMARY OF THE INVENTION

The present invention relates to an asphalt composition containing an asphalt and a polyester resin, where in:
the polyester resin composition contains a polyester resin and a hydrocarbon-based compound (i),
the polyester resin having a structural unit derived from an alcohol component and a structural unit derived from a carboxylic acid component, the carboxylic acid component containing at least one succinic acid compound selected from the group consisting of an alkylsuccinic acid and an alkenylsuccinic acid,
the polyester resin composition has a glass transition point comprised between −70° C. and 30° C.,
the polyester resin composition is present in an amount of ≥0.5 parts by mass and ≤25 parts by mass relative to 100 parts by mass of the asphalt.

### DETAILED DESCRIPTION OF THE INVENTION

Asphalt pavement is required to develop a surface strength that is independent of weather conditions.

For example, in tropical regions, asphalt pavement surfaces are repeatedly exposed to high temperatures from sunlight and are also subjected to heavy rain. In asphalt pavement techniques in the related art, when the pavement surface subjected to heavy rain is heated again, water that penetrated through the gaps between aggregate and asphalt may undergo a heat expansion, thus significantly impairing the bonding strength between the aggregates and the asphalt.

Per PTL 1 application, an asphalt composition having a high peeling resistance even under alkaline conditions is disclosed. However, in an environment in which a cycle of heating and cooling is repeated in the presence of water, the bonding strength between aggregate and asphalt may not be retained sufficiently.

The present invention relates to an asphalt composition that is used to form an asphalt pavement having a peeling resistance that can promote a bonding strength between aggregates and asphalt, even after several heating and cooling cycles in the presence of water (hereinafter referred to simply as peeling resistance), and also having a high rutting resistance under flooded conditions.

The present invention relates to the following [1] to [2].

[1] An asphalt composition containing an asphalt and a polyester resin composition, wherein,
the polyester resin composition contains a polyester resin and a hydrocarbon-based compound (i),
the polyester resin having a structural unit derived from an alcohol component and a structural unit derived from a carboxylic acid component, wherein the carboxylic acid component contains at least one succinic acid compound selected from the group consisting of an alkylsuccinic acid and an alkenylsuccinic acid,
the polyester resin composition having a glass transition point comprised between −70° C. and 30° C.,
the polyester resin composition is present in an amount of ≥0.5 parts by mass and ≤25 parts by mass relative to 100 parts by mass of the asphalt.

[2] An asphalt modifier containing a polyester resin and a hydrocarbon-based compound (i), wherein
the polyester resin has a structural unit derived from an alcohol component and a structural unit derived from a carboxylic acid component, wherein the carboxylic acid component contains at least one succinic acid compound selected from the group consisting of an alkylsuccinic acid and an alkenylsuccinic acid,
the asphalt modifier has a glass transition point comprised between −70° C. and 30° C.

### [Asphalt Composition]

The present invention is an asphalt composition containing an asphalt and a polyester resin composition, wherein:
the polyester resin composition contains a polyester resin and a hydrocarbon-based compound (i),
the polyester resin has a structural unit derived from an alcohol component and a structural unit derived from a carboxylic acid component, the carboxylic acid component containing at least one succinic acid compound selected from the group consisting of an alkylsuccinic acid and an alkenylsuccinic acid,
the polyester resin composition has a glass transition point comprised between −70° C. and 30° C.,
the polyester resin composition is contained in an amount of ≥0.5 parts by mass and ≤25 parts by mass relative to 100 parts by mass of the asphalt.

The present invention discloses an asphalt composition that is used to form an asphalt pavement having a peeling resistance that can promote a bonding strength between aggregates and asphalt, even after several heating and cooling cycles in the presence of water (hereinafter referred to simply as peeling resistance).

The present inventors discovered that the aforementioned problem can be resolved with an asphalt composition containing a specific amount of a polyester resin composition made of a specific polyester resin and a hydrocarbon-based compound (i), and having a specific glass transition point.

The reason why the effect of the present invention is achieved has not been elucidated yet but is illustrated as following.

In asphalt pavement, when subjected to heating and cooling cycles in the presence of water, water penetrates the gap between the aggregates and the asphalt film. Due to the expansion and contraction of water when temperature changes, the gap undergoes expansion, resulting in a tendency of the asphalt film to peel off.

In contrast, in a pavement surface using the asphalt composition of the present invention, we can anticipate the following. The hydrocarbon-based compound (i) which is the hydrophobic compound in the polyester resin composition first penetrates into the gap between the aggregates and asphalt film. Next, the polyester resin, having a structural unit derived from at least one succinic acid compound selected from the group consisting of an alkylsuccinic acid and an alkenylsuccinic acid, that has a high affinity to the hydrocarbon-based compound (i), having a specific low glass transition point characterized by a high molecular chain motility even at normal temperature, is attracted to the hydrocarbon-based compound (i) that has moved to the interface between aggregate and asphalt to fill the gap between aggregates and asphalt, resulting from the temperature expansion of water.

In other words, the following interpretation is made. Even when a gap is formed between the aggregates and asphalt film by an external force, the hydrocarbon-based compound (i) attracts the polyester resin which has a high mobility and a specific low glass transition point to fill the gap. Accordingly, even under several cycles of heating and cooling in the presence of water, the bonding strength between the aggregates and asphalt may be maintained. Therefore, as a result of the retained bonding strength between the aggregates and asphalt, the overall strength of the pavement surface is also improved, providing a high durability performance, such as rutting resistance.

The definitions and the like of the terms used in the description herein will be shown below.

In the polyester resin, the “structural unit derived from an alcohol component” means a structure obtained by removing a hydrogen atom from a hydroxy group of the alcohol component, and the “structural unit derived from a carboxylic acid component” means a structure obtained by removing a hydroxy group from a carboxy group of the carboxylic acid component.

The “carboxylic acid component” means a concept that encompasses not only a carboxylic acid but also an anhydride which decomposes in a reaction to produce an acid and an alkyl ester (for example, the alkyl group has 1 to 3 carbon atoms) of a carboxylic acid. In the case where the carboxylic acid component is an alkyl ester of a carboxylic acid, the number of carbon atoms of the alkyl group which is an alcohol residue of the ester is not counted in the number of carbon atoms of the carboxylic acid.

Bisphenol A refers to 2,2-bis(4-hydroxyphenyl)propane.

### {Asphalt}

The asphalt composition of the present invention contains a petroleum/bituminous material.

Various bituminous can be used in the present invention. Examples thereof include a straight/non-modified asphalt, which is a bituminous material for surface pavement, and a modified asphalt.

The straight asphalt means a residual bituminous substance obtained by subjecting a crude oil to atmospheric distillation equipment, reduced-pressure distillation equipment, or the like.

Examples of the modified asphalt include a blown asphalt; and a polymer-modified asphalt modified with a polymer material, such as a thermoplastic elastomer or a thermoplastic resin (which may be hereinafter referred to as a “polymer-modified asphalt”). The blown asphalt means an asphalt obtained in such a manner that a mixture of a straight asphalt and a heavy oil is heated and then oxidized by blowing air therein.

The asphalt is preferably selected from a straight asphalt and a polymer-modified asphalt. A polymer-modified asphalt is more preferred from the viewpoint of durability of asphalt pavement, and a straight asphalt is more preferred from the viewpoint of versatility.

### <<Thermoplastic Elastomer>>

Examples of the thermoplastic elastomer in the polymer-modified asphalt include at least one polymer selected from a styrene-butadiene block copolymer, a styrene-butadiene-styrene block copolymer, a styrene-butadiene random copolymer, a styrene-isoprene block copolymer, a styrene-isoprene-styrene block copolymer, a styrene-isoprene random copolymer, an ethylene-vinyl acetate copolymer, an ethylene acrylate ester copolymer, a styrene-ethylene-butylene-styrene copolymer, a styrene-ethylene-propylene-styrene copolymer, a polyurethane-based thermoplastic elastomer, a polyolefin-based thermoplastic elastomer, an isobutylene-isoprene copolymer, polyisoprene, polychloroprene, a synthetic rubber other than these materials, and a natural rubber.

Among them, the thermoplastic elastomer is, from the viewpoint of durability of the asphalt pavement, preferably at least one selected from a styrene/butadiene block copolymer, a styrene/butadiene/styrene block copolymer, a styrene/butadiene random copolymer, SI, a styrene/isoprene/styrene block copolymer, a styrene/isoprene random copolymer, and an ethylene/acrylate ester copolymer, more preferably at least one selected from a styrene/butadiene block copolymer, a styrene/butadiene/styrene block copolymer, a styrene/butadiene random copolymer, a styrene/isoprene block copolymer, a styrene/isoprene/styrene block copolymer, and a styrene/isoprene random copolymer, further preferably at least one selected from a styrene/butadiene random copolymer and a styrene/butadiene/styrene block copolymer.

The content of the thermoplastic elastomer in the polymer-modified asphalt is, from the viewpoint of durability of the asphalt pavement, preferably ≥0.1% by mass, more preferably ≥0.5% by mass, further preferably ≥1% by mass, and is preferably ≤30% by mass, more preferably ≤15% by mass, further preferably ≤5% by mass.

The total content of the straight asphalt and the polymer-modified asphalt in the asphalt composition is, from the viewpoint of asphalt mix performance, preferably ≥60% by mass, more preferably ≥65% by mass, further preferably ≥70% by mass, and, from the viewpoint of storage stability, preferably ≤99.5% by mass, more preferably ≤99% by mass, further preferably ≤98% by mass.

### {Polyester Resin Containing Composition}

The asphalt composition of the present invention contains a polyester resin composition, wherein

The polyester resin composition contains a polyester resin and a hydrocarbon-based compound (i), wherein
the polyester resin has a structural unit derived from an alcohol component and a structural unit derived from a carboxylic acid component, wherein the carboxylic acid component contains at least one succinic acid compound selected from the group consisting of an alkylsuccinic acid and an alkenylsuccinic acid,
the polyester resin composition having a glass transition point comprised between −70° C. and 30° C.

The polyester resin and the hydrocarbon-based compound (i) is described below.

### <<Polyester Resin>>

The polyester resin has a structural unit derived from an alcohol component and a structural unit derived from a carboxylic acid component, the carboxylic acid component containing at least one succinic acid compound selected from the group consisting of an alkylsuccinic acid and an alkenylsuccinic acid.

Properties of the alcohol component, carboxylic acid component, and polyester resin are described below.

### <Alcohol Component>

Examples of the alcohol component include aliphatic diols, aromatic diols, trihydric or higher polyhydric alcohols, and polyalkylene glycols. The alcohol components may be used alone or in combination with two or more alcohols.

Examples of the aliphatic diols include a chain aliphatic diols and an alicyclic diols, wherein

The chain aliphatic diol are preferably linear or branched chain aliphatic diols having carbon atoms comprised between 2 and 12, more preferably a linear or branched chain aliphatic diol having carbon atoms comprised between 2 and 8.

Specific examples of chain aliphatic diols include ethylene glycol, 1,2-propanediol, 1,3-propanediol, 1,3-butanediol, 1,4-butanediol, 1,4-butenediol, 1,5-pentanediol, 1,6-hexanediol, neopentyl glycol, 1,10-decanediol, and 1,12-dodecanediol.

Examples of alicyclic diols include hydrogenated bisphenol A (2,2-bis(4-hydroxycyclohexyl)propane), alkylene oxide adduct of hydrogenated bisphenol A, cyclohexanediol, and cyclohexanedimethanol.

Examples of aromatic diols include bisphenol A and alkylene oxide adduct of bisphenol A. An example of the alkylene oxide adduct of bisphenol A is an alkylene oxide adduct of bisphenol A represented by the following formula (I).

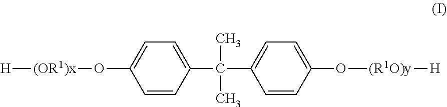

In the formula (I), OR¹ and R¹O each represent an alkylene oxide; R¹ represents an alkylene group having 2 or 3 carbon atoms; and x and y each represent a positive number showing the average number of moles of the alkylene oxide added, provided that the sum of x and y is preferably ≥1, more preferably ≥1.5 or more, and preferably ≤16, more preferably ≤8, further preferably ≤4.

Examples of alkylene oxide adducts of bisphenol A represented by the formula (I) include a propylene oxide adduct of bisphenol A and an ethylene oxide adduct of bisphenol A. One of the alkylene oxide adducts of bisphenol A can be used alone or in combination with two or more alkylene oxides.

The trihydric or higher polyhydric alcohol is preferably a trihydric alcohol. Examples of trihydric or higher polyhydric alcohol include glycerol, pentaerythritol, trimethylolpropane, and sorbitol.

Examples of polyalkylene glycols include homopolymers, such as polyethylene glycol, polypropylene glycol, and polybutylene glycol, and a copolymer of two or more selected from ethylene glycol, propylene glycol, and butylene glycol. The polyalkylene glycol is preferably a homopolymer, and more preferably polypropylene glycol.

The number average molecular weight of the polyalkylene glycol is, from the viewpoint of enhancing the affinity with asphalt to improve the peeling resistance, preferably ≥100, more preferably ≥200, further preferably ≥250, and preferably ≤2,000, more preferably ≤1,000, further preferably ≤800.

From the viewpoint of controlling properties such as the glass transition point, the acid value, the hydroxyl value, the number average molecular weight, and the weight average molecular weight of the polyester resin, the alcohol component can further contain a monohydric aliphatic alcohol. Examples of monohydric aliphatic alcohols include lauryl alcohol, myristyl alcohol, palmityl alcohol, and stearyl alcohol. One of the monohydric aliphatic alcohols can be used alone or in combination with two or more alcohols.

From the viewpoint of enhancing the peeling resistance, the alcohol component contains at least one alcohol selected from the group consisting of chain aliphatic diols and polyalkylene glycols.

The chain aliphatic diols are preferably ethylene glycol, 1,2-propanediol, 1,4-butanediol, or 1,6-hexanediol.

The polyalkylene glycol is preferably polypropylene glycol.

The total content of the chain aliphatic diol and the polyalkylene glycol in the alcohol component is, preferably ≥50% by mole, more preferably ≥70% by mole, further preferably ≥80% by mole, furthermore preferably ≥90% by mole, and ≤100% by mole.

### <Carboxylic Acid Component>

From the viewpoint of the peeling resistance, the carboxylic acid component contains at least one succinic acid compound selected from the group consisting of alkylsuccinic acid and alkenylsuccinic acid.

### (Succinic Acid Compound)

The number of carbon atoms of the alkyl group in the alkylsuccinic acid and the alkenyl group in the alkenylsuccinic acid is, preferably ≥9, more preferably ≥10, and preferably ≤19, more preferably ≤15, further preferably ≤13.

The alkyl group and the alkenyl group may be linear or branched chain but are preferably branched chain. The branch structure may be present in any part of the alkyl and alkenyl groups.

Thus, the polyester resin preferably contains a structural unit derived from a branched alkylsuccinic acid or a structural unit derived from a branched alkenylsuccinic acid.

The alkylsuccinic acid and the alkenylsuccinic acid are each, preferably a mixture containing two or more kinds. The “kind” herein refers to a concept based on an alkyl group or an alkenyl, alkyl or alkenyl groups having different lengths of carbon chain, or structural isomers are considered as different kinds of alkylsuccinic or alkenylsuccinic acids.

When alkylsuccinic acid and/or alkenylsuccinic acid is a mixture containing two or more kinds, the number of carbon atoms of the alkyl group in the alkylsuccinic acid and the alkenyl group in the alkenylsuccinic acid is the average of number of carbon atoms of the alkyl groups in the alkylsuccinic acids and the alkenyl groups in the alkenylsuccinic acids contained in the carboxylic acid component.

From enhanced peeling resistance perspective, the alkylsuccinic acid is preferably a mixture containing two or more kinds of alkylsuccinic acids each having a branched alkyl group preferably having ≥9, more preferably ≥10, and preferably ≤19, more preferably ≤14, further preferably ≤12 carbon atoms. The alkenylsuccinic acid is preferably a mixture containing two or more kinds of alkenylsuccinic acids each having a branched alkenyl group preferably having ≥9, more preferably ≥10, and preferably ≤19, more preferably ≤15, further preferably ≤13 carbon atoms.

The alkylsuccinic acid and the alkenylsuccinic acid are preferably derived from a compound having an alkylene group (alkylene compound) and at least one acid selected from maleic acid, fumaric acid, and an anhydride thereof.

The alkylene compound is a compound having preferably ≥9, more preferably ≥10, and preferably ≤19, more preferably ≤14 carbon atoms. Specifically, compounds derived from ethylene, propylene, isobutylene, n-butylene, for example, a trimer or tetramer thereof, are preferred. As a suitable material used for efficient synthesis of alkylene compounds, a small molecular weight propylene tetramer is preferred.

The alkylsuccinic and alkenylsuccinic acids can be obtained by any production method, and, for example, can be obtained by means of the ene reaction by heating a mixture of an alkylene compound and at least one selected from maleic acid, fumaric acid, and anhydride thereof (see JP 48-23405 A, JP 48-23404 A, U.S. Pat. No. 3,374,285). Among maleic acid, fumaric acid, and anhydride thereof, maleic anhydride is preferred for its better reactivity. Examples of suitable catalysts used in synthesis of the alkylene compound include liquid phosphoric acid, solid phosphoric acid, tungsten, and a boron trifluoride complex. From the viewpoint of easily controlling the number of structural isomers to enhance the rut resistance, a method in which random polymerization is followed by distillation is preferred.

The carboxylic acid component can further contain other than the succinic acid compound described above. Examples of the carboxylic acid component other than the succinic acid compound include an aliphatic dicarboxylic acid other than the succinic acid compound, an aromatic dicarboxylic acid, and a tribasic or higher and hexabasic or lower polybasic carboxylic acid. One of the carboxylic acid components other than the succinic acid compound can be used alone or in combination with two or more acids.

Examples of the aliphatic dicarboxylic acid other than the succinic acid compound include aliphatic dicarboxylic acids having a main chain with preferably ≥4, and preferably ≤10, more preferably ≤8, more preferably ≤6 carbon atoms, for example, fumaric acid, maleic acid, oxalic acid, malonic acid, citraconic acid, itaconic acid, glutaconic acid, adipic acid, suberic acid, azelaic acid, sebacic acid, dodecanedioic acid, anhydride thereof, and alkyl esters thereof (for example, the number of carbon atoms of the alkyl group is ≥1 or more and ≤3).

Examples of the aromatic dicarboxylic acid include phthalic acid, terephthalic acid, isophthalic acid, naphthalene dicarboxylic acid, anhydride thereof, and alkyl esters thereof (for example, the number of carbon atoms of the alkyl group is ≥1 and ≤3).

The tribasic, or higher, and hexabasic, or lower polybasic carboxylic acid is preferably a tribasic carboxylic acid. Examples of the tribasic or higher and hexabasic or lower polybasic carboxylic acid include trimellitic acid, 2,5,7-naphthalene tricarboxylic acid, pyromellitic acid, or anhydride thereof.

From the viewpoint of controlling properties such as the glass transition point, the acid value, the hydroxyl value, the number average molecular weight, and the weight average molecular weight of the polyester resin, the carboxylic acid component can further contain monobasic aliphatic carboxylic acids. Examples of the monobasic aliphatic carboxylic acid include monobasic aliphatic carboxylic acids having ≥12 and ≤20 carbon atoms, such as lauric acid, myristic acid, palmitic acid, stearic acid, and alkyl esters thereof (the number of carbon atoms of the alkyl group is ≥1 and ≤3). One of the monobasic aliphatic carboxylic acids can be used alone or in combination with two or more acids.

From enhanced peeling resistance perspective, the total content of the succinic acid compounds in the carboxylic acid component is preferably ≥50% by mole, more preferably ≥70% by mole, further preferably ≥80% by mole, furthermore preferably ≥90% by mole, and ≤100% by mole.

<Molar Ratio of Structural Unit Derived from Carboxylic Acid Component to Structural Unit Derived from Alcohol Component>

The molar ratio of the structural unit derived from a carboxylic acid component to the structural unit derived from an alcohol component [carboxylic acid component/alcohol component] is preferably ≥0.7, more preferably ≥0.8, further preferably ≥0.85, and preferably ≤1.3, more preferably ≤1.2, further preferably ≤1.0.

### <Properties of Polyester Resin>

From enhanced peeling resistance perspective, the glass transition point (Tg) of the polyester resin is preferably ≥−70° C., more preferably ≥−60° C., further preferably ≥−55° C., and preferably ≤30° C., more preferably ≤10° C., further preferably ≤0° C.

From same perspective, the acid value of the polyester resin is preferably ≥0 mgKOH/g, more preferably ≥1 mgKOH/g, further preferably ≥2 mgKOH/g, and preferably ≤20 mgKOH/g, more preferably ≤15 mgKOH/g, further preferably ≤13 mgKOH/g.

From the same perspective, the hydroxyl value of the polyester resin is preferably ≥5 mgKOH/g, more preferably ≥10 mgKOH/g, further preferably ≥13 mgKOH/g, and preferably ≤40 mgKOH/g, more preferably ≤30 mgKOH/g, further preferably ≤25 mgKOH/g.

From the same perspective, the sum of the acid value and the hydroxyl value of the polyester resin is preferably ≥5 mgKOH/g, more preferably ≥10 mgKOH/g, further preferably ≥13 mgKOH/g, and preferably ≤40 mgKOH/g, more preferably ≤30 mgKOH/g, further preferably ≤25 mgKOH/g.

From the same perspective, the number average molecular weight (Mn) of the polyester resin is, from the same point of view, preferably ≥500, more preferably ≥1,000, further preferably ≥1,500, and preferably ≤10,000, more preferably ≤7,000, further preferably ≤5,000.

From the same perspective, the weight average molecular weight (Mw) of the polyester resin is, from the same point of view, preferably ≥2,000, more preferably ≥5,000, further preferably ≥8,000, and preferably ≤100,000, more preferably ≤80,000, further preferably ≤50,000.

The glass transition point, the acid value, the hydroxyl value, the number average molecular weight, and the weight average molecular weight of the polyester resin can be measured in the same manner as in the methods described in the section of Examples except for conducting them for a polyester resin alone.

The glass transition point of the polyester resin can be determined by calculation using the following Gordon-Taylor equation based on the glass transition point of the alcohol component alone and that of the carboxylic acid component alone, which are polymerization monomers constituting the polyester resin. The Gordon-Taylor equation is used for calculating a glass transition point of a mixture system, such as a polymer-plasticizer system.

$$1 / Tg = ( {W}_{1} / {Tg}_{1} ) + ( {W}_{2} / {Tg}_{2} )$$

$${W}_{1} + {W}_{2} = 1$$

In the Gordon-Taylor equation, Tg represents a glass transition point of a polymer-plasticizer mixture system, Tg₁ represents a glass transition point of a polymer, and Tg₂ represents a glass transition point of a plasticizer. The unit of the temperature is K. W₁ represents the proportion of the polymer by mass and W₂ represents the proportion of the plasticizer by mass.

As a glass transition point of a homopolymer of each polymerization monomer in the Gordon-Taylor equation, for example, a value shown in the Polymer Handbook Third Edition (Wiley-Interscience, 1989) can be used.

The acid value and the hydroxyl value of the polyester resin can be determined by calculation based on the ratio of charged amounts of the alcohol component and the carboxylic acid component in producing the polyester resin.

The glass transition point, the acid value, the hydroxyl value, the number average molecular weight, and the weight average molecular weight of the polyester resin can be controlled by the composition of raw material monomers, the molecular weight, the amount of a catalyst, or reaction conditions.

The polyester resin may be a polyester resin that is modified to such an extent that the characteristics thereof are not substantially impaired. Specific examples of the modified polyester resin include a graft or block polyester resin modified with phenol, urethane, epoxy, or the like, according to the methods described in JP 11-133668 A, JP 10-239903 A, and JP 8-20636 A. A preferred example of the modified polyester resin is a urethane modified polyester resin obtained through urethane-elongation of a polyester resin with a polyisocyanate compound.

<<Hydrocarbon-Based Compound (i)>>

Examples of the hydrocarbon-based compound (i) include hydrocarbon compounds constituted only of a carbon atom and a hydrogen atom, such as an alkane which is a saturated hydrocarbon compound and an alkene which is an unsaturated hydrocarbon compound. Alkene is also referred to as olefin.

From enhanced peeling resistance perspective, the hydrocarbon-based compound (i) has preferably ≥9, more preferably ≥10, and preferably ≤18, more preferably ≤14 carbon atoms.

The preferred hydrocarbon-based compound (i) is a compound derived from ethylene, propylene, isobutylene, or n-butylene, for example, a trimer or tetramer thereof.

Among them, the hydrocarbon-based compound (i), propylene tetramer is most preferred.

From enhanced peeling resistance perspective, the hydrocarbon-based compound (i) is preferably a mixture containing two or more kinds. Regarding the concept of the “kind” herein, hydrocarbon-based compounds (i) having different lengths of carbon chain or structural isomers are considered as different kinds of hydrocarbon-based compounds (i).

When the hydrocarbon-based compound (i) is a mixture containing two or more kinds, the number of carbon atoms of the hydrocarbon-based compound (i) is the average of the numbers of carbon atoms of the hydrocarbon-based compounds (i) contained in the carboxylic acid component.

From the same perspective, the ratio of the number of carbon atoms of the succinic acid compound in the carboxylic acid component of the polyester resin to the number of carbon atoms of the hydrocarbon-based compound (i) [number of carbon atoms of succinic acid compound/number of carbon atoms of hydrocarbon-based compound (i)] is preferably close to 1, and specifically, preferably ≥0.65, more preferably ≥0.75, and preferably ≤1.4, more preferably ≤1.5.

<Properties of Hydrocarbon-Based Compound (i)>

From the same perspective, the number average molecular weight (Mn) of the hydrocarbon-based compound (i) is preferably ≥100, more preferably ≥110, further preferably ≥120, and preferably ≤300, more preferably ≤280, further preferably ≤250.

<<Content of Polyester Resin and Hydrocarbon-Based Compound (i)>>

From the same perspective, the content of the polyester resin, in the polyester resin composition, is in 100% by mass of the polyester resin composition, preferably ≥99.5% by mass, more preferably ≥99.65% by mass, further preferably ≥99.6% by mass, and preferably ≤99.9% by mass, more preferably ≤99.88% by mass, further preferably ≤99.85% by mass.

From the same perspective, the content of the hydrocarbon-based compound (i) in the polyester resin composition is 100% by mass of the polyester resin composition, preferably ≥0.1% by mass, more preferably ≥0.12% by mass, further preferably ≥0.15% by mass, and preferably ≤0.5% by mass, more preferably ≤0.45% by mass, further preferably ≤0.4% by mass.

From the same perspective, the total content of the structural unit derived from a succinic acid compound in the polyester resin and the hydrocarbon-based compound (i) in the polyester resin composition is 100% by mass of the polyester resin composition, preferably ≥30% by mass, more preferably ≥31% by mass, further preferably ≥32% by mass, and preferably ≤90% by mass, more preferably ≤85% by mass, further preferably ≤80% by mass.

The total content of the structural unit derived from a succinic acid compound in the polyester resin and the hydrocarbon-based compound (i) can be determined by calculation based on the ratio of charged amounts of the alcohol component, the carboxylic acid component, and the hydrocarbon-based compound (i).

### <<Properties of Polyester Resin-Containing Composition>>

From enhanced peeling resistance perspective:

The glass transition point (Tg) of the polyester resin composition is comprised between −70° C. and 30° C., preferably ≥−65° C., more preferably ≥−60° C., further preferably ≥−55° C., and preferably ≤25° C., more preferably ≤10° C., further preferably ≤0° C.

From the perspective of enhanced peeling resistance through improved affinity to asphalt, the acid value of the polyester resin composition is preferably ≥0 mgKOH/g, more preferably ≥1 mgKOH/g, further preferably ≥2 mgKOH/g, and preferably ≤20 mgKOH/g, more preferably ≤15 mgKOH/g, further preferably ≤13 mgKOH/g.

From the same perspective, the hydroxyl value of the polyester resin composition is preferably ≥5 mgKOH/g, more preferably ≥10 mgKOH/g, further preferably ≥13 mgKOH/g, and preferably ≤40 mgKOH/g, more preferably ≤30 mgKOH/g, further preferably ≤25 mgKOH/g.

From the same perspective, the sum of the acid value and the hydroxyl value of the polyester resin composition is preferably ≥5 mgKOH/g, more preferably ≥10 mgKOH/g, further preferably ≥13 mgKOH/g, and preferably ≤40 mgKOH/g, more preferably ≤30 mgKOH/g, further preferably ≤25 mgKOH/g.

From the same perspective, the number average molecular weight (Mn) of the polyester resin containing composition is preferably ≥500, more preferably ≥1,000, further preferably ≥1,500, and preferably ≤10,000, more preferably ≤7,000, further preferably ≤5,000.

From the same perspective, the weight average molecular weight (Mw) of the polyester resin-containing composition is preferably ≥2,000, more preferably ≥5,000, further preferably ≥8,000, and preferably ≤100,000, more preferably ≤80,000, further preferably ≤50,000.

The glass transition point, the acid value, the hydroxyl value, the number average molecular weight, and the weight average molecular weight of the polyester resin composition can be measured by the methods described in the section of Examples.

### <Content of Polyester Resin-Containing Composition>

From storage stability perspective, the content of the polyester resin in the asphalt composition is comprised between 0.5 parts by mass and 25 parts by mass, preferably ≥1% by mass, more preferably ≥1.5 parts by mass, further preferably ≥2% by mass, and preferably ≤22% by mass, more preferably ≤20% by mass, further preferably ≤15% by mass.

### <Production Method of Polyester Resin Composition>

The method of producing the polyester resin composition contained in the asphalt composition of the present invention is not particularly limited. For example, the polyester resin composition can be obtained by, in the presence of the hydrocarbon-based compound (i), subjecting the aforementioned alcohol component and carboxylic acid component to a polycondensation reaction.

The polyester resin composition can also be obtained by subjecting the aforementioned alcohol component and carboxylic acid component to polycondensation to obtain a polyester resin, which is then mixed with the hydrocarbon-based compound (i).

The amounts of the alcohol component and the carboxylic acid component blended may be such amounts that provide a molar ratio of the structural unit derived from the carboxylic acid component to the structural unit derived from the alcohol component (carboxylic acid component/alcohol component) within the aforementioned numeral range.

The temperature of the polycondensation reaction is, from the viewpoint of the reactivity, preferably ≥160° C., more preferably ≥180° C., further preferably ≥190° C., and preferably ≤260° C., more preferably ≤250° C., further preferably ≤240° C.

In the polycondensation reaction, from the viewpoint of the reaction rate, an esterification catalyst can be used. An example of the esterification catalyst is a tin(II) compound having no Sn—C bond, such as tin(II) di(2-ethylhexanoate). The amount of the esterification catalyst used is relative to 100 parts by mass of the total amount of the alcohol component and the carboxylic acid component, preferably ≥0.01 parts by mass, more preferably ≥0.1 parts by mass, further preferably ≥0.2 parts by mass, and preferably ≤1.5 parts by mass, more preferably ≤1.0 parts by mass, further preferably ≤0.6 parts by mass.

In the polycondensation reaction, in addition to the esterification catalyst, a co-catalyst can be used. An example of the co-catalyst is a pyrogallol compound, such as gallic acid. The amount of the co-catalyst used is, relative to 100 parts by mass of the total amount of the alcohol component and the carboxylic acid component, preferably ≥0.001 parts by mass, more preferably ≥0.005 parts by mass, further preferably ≥0.01 parts by mass, and preferably ≤0.15 parts by mass, more preferably ≤0.10 parts by mass, further preferably ≤0.05 parts by mass.

### [Production Method of Asphalt Composition]

The asphalt composition of the present invention may be produced by mixing an asphalt and the polyester resin composition. Specifically, the asphalt composition may be obtained in such a manner that an asphalt is melted with heat, the polyester resin composition is added thereto, and the components are mixed with a standard mixer until the polyester resin composition is uniformly dispersed in the asphalt.

Examples of the standard mixer include a homogenizer, a dissolver, a paddle mixer, a ribbon mixer, a screw mixer, a planetary mixer, a vacuum counterflow mixer, a roll mill, and a twin-screw extruder.

The temperature to mix the asphalt and polyester resin composition is, from the viewpoint of uniformly dispersing the polyester resin composition in the asphalt, preferably ≥140° C., more preferably ≥150° C., and preferably ≤190° C., more preferably ≤180° C., further preferably ≤170° C.

The time for mixing the asphalt and the polyester resin composition is, from the viewpoint of uniformly dispersing the polyester resin composition in the asphalt, preferably ≥1 minute, more preferably ≥10 minutes, further preferably ≥30 minutes. To prevent the thermal degradation of the asphalt composition, the mixing time is preferably ≤48 hours, more preferably ≤30 hours, further preferably ≤24 hours.

The asphalt composition of the present invention is a binder composition in the asphalt mixture, and, for example, aggregates are added to the asphalt composition to prepare an asphalt mixture, which can then be used to form asphalt pavement and pave a road.

### [Asphalt Mixture]

An asphalt mixture as a suitable use example of the asphalt composition is described as following:

The asphalt mixture contains aggregates and an asphalt composition. Accordingly, the asphalt mixture contains at least an aggregate, an asphalt, and the polyester resin composition.

### {Aggregate}

Any aggregate type such as crushed stone, cobbled stone, ballast, sand, asphalt-recycled aggregate, and ceramic can be used. Coarse aggregates having a particle diameter ≥2.36 mm and a fine aggregate having a particle diameter ≤2.36 mm can be used. Preferably, the aggregate is a combination of a coarse aggregates and a fine aggregates.

From the durability of the asphalt pavement perspective, the content of the aggregate in the asphalt mixture is 100% by mass of the asphalt mixture, preferably ≥85% by mass, more preferably ≥90% by mass, further preferably ≥92% by mass, and is preferably ≤98% by mass, more preferably ≤97% by mass, further preferably ≤96% by mass.

### {Additive}

Various additives that are commonly used in asphalt mixtures, such as a film forming agent, a thickening agent, and an emulsifier, may be added, as required, to the asphalt mixture, in addition to the aggregates, the asphalt, and the polyester resin composition described above.

The total content of the additives is preferably ≤50% by mass, more preferably ≤25% by mass, further preferably ≤5% by mass, in 100% by mass of the asphalt mixture.

### [Production Method of Asphalt Mixture]

The production method of the asphalt mixture is not particularly limited, and the asphalt mixture may be produced by any production method. In general, the asphalt mixture can be produced by mixing aggregates with an asphalt composition. A specific example thereof is a method in which the asphalt composition is added to and mixed with heated aggregates.

To ensure a uniform and homogeneous mixing of the materials, the temperature of the heated aggregates is preferably ≥130° C., more preferably ≥150° C., further preferably ≥160° C. To prevent the thermal deterioration of the asphalt, the temperature of the heated aggregates is preferably ≤230° C., more preferably ≤200° C., further preferably ≤170° C.

From materials mixing uniformity and homogeneity, the temperature in mixing the aggregate and the asphalt composition is preferably ≥130° C., more preferably ≥150° C., further preferably ≥160° C., and from to prevent the thermal deterioration of the asphalt, the temperature is preferably ≤230° C., more preferably ≤200° C., further preferably ≤170° C.

The time for mixing the aggregate and the asphalt composition is not particularly limited and is preferably ≥30 seconds, more preferably ≥1 minute, further preferably ≥2 minutes, and is preferably ≤2 hours, more preferably ≤1 hour, and further preferably ≤30 minutes.

The production method of the asphalt mixture preferably includes, after mixing the aggregate and the asphalt composition, a step of retaining the resulting asphalt mixture at the mixing temperature or a temperature higher than the mixing temperature.

In the step of retaining the asphalt mixture, the mixture may be further mixed.

The retaining time is preferably ≥0.5 hour, more preferably ≥1 hour, further preferably ≥1.5 hours, and the upper limit of the time is not particularly limited, and may be, for example, approximately 48 hours.

### [Road Pavement Method]

The asphalt mixture is suitable for road pavement, and as described above, the asphalt mixture obtained by adding an aggregate to the asphalt composition is used for road pavement.

The road pavement method includes a step of laying the asphalt mixture on a road to form an asphalt pavement material layer. Specifically, the road pavement method may include a step of mixing the asphalt composition and heated aggregates to prepare an asphalt mixture (step 1), and a step of laying down the asphalt mixture obtained in the step 1 on a road to form an asphalt pavement material layer (step 2). The asphalt pavement material layer is preferably a base course or a surface course.

### [Asphalt Modifier]

The asphalt modifier of the present invention contain a polyester resin and a hydrocarbon-based compound (i), wherein
the polyester resin has a structural unit derived from an alcohol component and a structural unit derived from a carboxylic acid component, wherein the carboxylic acid component contains at least one succinic acid compound selected from the group consisting of an alkylsuccinic acid and an alkenylsuccinic acid,
the asphalt modifier has a glass transition point comprised between −70° C. and 30° C.

The asphalt modifier of the present invention can be used, for example, to prepare an asphalt composition by mixing it with an asphalt in an amount of ≥0.5 parts by mass and ≤25 parts by mass relative to 100 parts by mass of the asphalt. Aggregates are added to the resulting asphalt composition to prepare an asphalt mixture, which can then be used for pavement.

From enhanced peeling resistance perspective, the glass transition point (Tg) of the asphalt modifier is comprised between −70° C. and 30° C., preferably ≥−65° C., more preferably ≥−60° C., further preferably ≥−55° C., and preferably ≤25° C., more preferably ≤10° C., further preferably ≤0° C.

Preferred aspects of the polyester resin and the hydrocarbon-based compound (i) constituting the asphalt modifier are the same as those in the asphalt composition.

Regarding the embodiments described above, the present invention further discloses the following asphalt composition.

### EXAMPLES

### [Measurement Method]

### (1) Measurement Method of Acid Value and Hydroxyl Value of Polyester Resin Composition or Polyester Resin

The acid value and the hydroxyl value of the polyester resin composition or the polyester resin were measured based on the method of JIS K0070:1992, provided that only the solvent for measurement was changed from the mixed solvent of ethanol and ether defined in JIS K0070:1992 to a mixed solvent of acetone and toluene (acetone:toluene=1:1 (by volume)).

### (2) Measurement Method of Glass Transition Point

The glass transition point of the polyester resin composition or the polyester resin were measured as follows. Using a differential scanning calorimetry “Q-100” (available from TA Instruments Japan Inc.), 0.01 to 0.02 g of a sample was measured into an aluminum pan. The sample was heated to 200° C. and then was cooled from the temperature to −80° C. at a temperature lowering rate of 10° C./min. Next, measurement was performed while increasing the temperature to 150° C. at a temperature rise rate of 10° C./min. A temperature at which an extension of a baseline in a region of the endothermic maximum peak temperature or lower was intersected with a tangential line having a maximum inclination of a curve in a region of from a rise-up portion of the peak to an apex of the peak was read as the glass transition point.

### (5) Measurement Method of Number Average Molecular Weight and Weight Average Molecular Weight of Polyester Resin Composition or Polyester Resin

A molecular weight distribution was measured by gel permeation chromatography (GPC) according to the following method, and a number average molecular weight (Mn) and a weight average molecular weight (Mw) of a polyester resin composition or a polyester resin were determined.

### (i) Preparation of Sample Solution

A sample was dissolved in tetrahydrofuran at 60° C. at a concentration of 0.5 g/100 mL. Thereafter, at a room temperature, the solution was filtered with a PTFE type membrane filter having a pore diameter of 0.2 μm (DISMIC-25JP, available from Toyo Roshi Kaisha, Ltd.) to remove insoluble components, thus preparing a sample solution.

### (ii) Measurement of Molecular Weight

With the measurement equipment and the analysis column described below, while allowing tetrahydrofuran as an eluent to flow therein at a flow rate of 1 mL/min, the column was stabilized in a thermostat chamber at 40° C. 100 μL of the sample solution obtained in the above (i) was injected thereto to perform measurement. The molecular weight of the sample was calculated based on the calibration curve provided in advance.

Measurement equipment: HLC-8320GPC (available from Tosoh Corporation)

Analysis column: GMHXL+G3000HXL (available from Tosoh Corporation)

The calibration curve was used which was created using several kinds of monodisperse polystyrene “A-500” (5.0×10²), “A-1000” (1.01×10³), “A-2500” (2.63×10³), “A-5000” (5.97×10³), “F-1” (1.02×10³), “F-2” (1.81×10⁴), “F-4” (3.97×10⁴), “F-10” (9.64×10⁴), “F-20” (1.90×10⁵), “F-40” (4.27×10⁵), “F-80” (7.06×10⁵), “F-128” (1.09×10⁶) (all available from Tosoh Corporation) as standard samples. The numeral in parentheses shows the molecular weight.

### Production Example 1 (Production of Polyester Resin Composition E-1)

The alcohol component, the carboxylic acid component, the hydrocarbon-based compound (i), and the esterification catalyst shown in Table 1 were put in a 10 L four-neck flask equipped with a nitrogen introducing tube, a dewatering conduit, a stirrer, and a thermocouple, and under a nitrogen atmosphere, the mixture was kept at 180° C. for 1 hour. Then, the temperature was increased to 220° C. at 10° C./hour over 4 hours. After reaching 220° C., the temperature and pressure were kept at 220° C. and 8.0 kPa until a target acid value was achieved, thereby obtaining a polyester resin-containing composition E-1.

The results of measurement of properties are shown in Table 1.

### Production Examples 2 to 7 and 10 (Production of Polyester Resin Compositions E-2, E-3, E-4, E-5, E-6, E-7, and C-3)

Polyester resins E-2, E-3, E-4, E-5, E-6, E-7, and C-3 were obtained in the same manner as in Production Example 1 except for using the alcohol component, the carboxylic acid component, the hydrocarbon-based compound (i), and the esterification catalyst shown in Table 1.

The results of measurement of properties were shown in Table 1.

### Production Examples 8 and 9 (Production of Polyester Resins C-1 and C-2)

Polyester resins C-1 and C-2 were obtained in the same manner as in Production Example 1 except for using the alcohol component, the carboxylic acid component, and the esterification catalyst shown in Table 1.

The results of measurement of properties were shown in Table 1.

TABLE 1

| | | | Production Example | | | | | |
|---|---|---|---|---|---|---|---|---|
| | | | 1 | | 2 | | 3 | |
| Kind of polyester resin-containing | | | E-1 | | E-2 | | E-3 | |
| composition or polyester resin | | | | | | | | |
| Raw material | Monomer composition | | Molar | Charged | Molar | Charged | Molar | Charged |
| monomer, etc. | | | ratio *7 | amount (g) | ratio *7 | amount (g) | ratio *7 | amount (g) |
| | Alcohol | 1,2- | | | | | 100 | 952 |
| | component | Propanediol | | | | | | |
| | | Ethylene glycol | | | | | | |
| | | 1,4-Butanediol | | | 100 | 1080 | | |
| | | 1,6-Hexanediol | 100 | 1307 | | | | |
| | | Propylene | | | | | | |
| | | glycol *1 | | | | | | |
| | | BPA-2PO | | | | | | |
| | | Adduct *2 | | | | | | |
| | | BPA-2EO | | | | | | |
| | | Adduct *3 | | | | | | |
| | Carboxylic | Alkenylsuccinic | 94.6 | 2680 | 94.6 | 2905 | 94.6 | 3033 |
| | acid | anhydride *4 | | | | | | |
| | component | Terephthalic | | | | | | |
| | | acid | | | | | | |
| | Hydrocarbon- | Propylene | 0.4 | 13.5 | 0.4 | 15 | 0.4 | 15.2 |
| | based | tetramer *5 | | | | | | |
| | compound (i) | | | | | | | |

| Esterification | Tin(II) di(2-ethylhexanoate) *6 | 20 | 20 | 20 |
|---|---|---|---|---|
| catalyst | (charged amount g) | | | |
| Content of hydrocarbon-based compound (i) *8 | | 0.34 | 0.37 | 0.38 |
| Total content of hydrocarbon-based compound | | 67.0 | 72.6 | 75.8 |
| (i) and alkenylsuccinic anhydride *9 | | | | |
| Properties | Glass transition point Tg | −26.6 | −16.0 | −2.8 |
| | (° C.) | | | |
| | Acid value (mgKOH/g) | 7 | 10 | 3 |
| | Hydroxyl value (mgKOH/g) | 19 | 19 | 14 |
| | Acid value + hydroxyl value | 26.0 | 29.2 | 16.6 |
| | (mgKOH/g) | | | |
| | Number average molecular | 3400 | 3200 | 2100 |
| | weight Mn | | | |
| | Weight average molecular | 48000 | 20000 | 9000 |
| | weight Mw | | | |

| | Production Example | | |
|---|---|---|---|
| | 4 | 5 | 6 |
| Kind of polyester resin-containing | E-4 | E-5 | E-6 |

| composition or polyester resin | | | | | | | | |
|---|---|---|---|---|---|---|---|---|
| Raw material | Monomer composition | | Molar | Charged | Molar | Charged | Molar | Charged |
| monomer, etc. | | | ratio *7 | amount (g) | ratio *7 | amount (g) | ratio *7 | amount (g) |
| | Alcohol | 1,2- | | | | | 100 | 952 |
| | component | Propanediol | | | | | | |
| | | Ethylene glycol | 100 | 813 | | | | |
| | | 1,4-Butanediol | | | | | | |
| | | 1,6-Hexanediol | | | | | | |
| | | Propylene | | | 100 | 2260 | | |
| | | glycol *1 | | | | | | |
| | | BPA-2PO | | | | | | |
| | | Adduct *2 | | | | | | |
| | | BPA-2EO | | | | | | |
| | | Adduct *3 | | | | | | |
| | Carboxylic | Alkenylsuccinic | 94.6 | 3171 | 94.6 | 1134 | 94.6 | 3033 |
| | acid | anhydride *4 | | | | | | |
| | component | Terephthalic | | | | | | |
| | | acid | | | | | | |
| | Hydrocarbon- | Propylene | 0.4 | 16 | 0.4 | 5.8 | 0.4 | 15.2 |
| | based | tetramer *5 | | | | | | |
| | compound (i) | | | | | | | |

| | | | | |
|---|---|---|---|---|
| Esterification | Tin(II) di(2-ethylhexanoate) *6 | 20 | 20 | 20 |

| | |
|---|---|
| catalyst | (charged amount g) |

| | | | |
|---|---|---|---|
| Content of hydrocarbon-based compound (i) *8 | 0.40 | 0.17 | 0.38 |
| Total content of hydrocarbon-based compound | 79.3 | 33.4 | 75.8 |

(i) and alkenylsuccinic anhydride *9

| | | | | |
|---|---|---|---|---|
| Properties | Glass transition point Tg | −4.7 | −51.3 | −3.8 |
| | (° C.) | | | |
| | Acid value (mgKOH/g) | 2 | 10 | 12 |
| | Hydroxyl value (mgKOH/g) | 16 | 23 | 24 |
| | Acid value + hydroxyl value | 18.0 | 33.0 | 36.0 |
| | (mgKOH/g) | | | |
| | Number average molecular | 2200 | 4900 | 1700 |
| | weight Mn | | | |
| | Weight average molecular | 9000 | 45000 | 3100 |

weight Mw

| | | | Production Example | | | |
|---|---|---|---|---|---|---|
| | | | 7 | | 8 | |
| Kind of polyester resin-containing | | | E-7 | | C-1 | |
| composition or polyester resin | | | | | | |
| Raw material | Monomer composition | | Molar | Charged | Molar | Charged |
| monomer, etc. | | | ratio *7 | amount (g) | ratio *7 | amount (g) |
| | Alcohol | 1,2- | | | | |
| | component | Propanediol | | | | |
| | | Ethylene glycol | | | | |
| | | 1,4-Butanediol | | | | |
| | | 1,6-Hexanediol | 100 | 1307 | | |
| | | Propylene | | | | |
| | | glycol *1 | | | | |
| | | BPA-2PO | | | 25 | 679 |
| | | Adduct *2 | | | | |
| | | BPA-2EO | | | 75 | 1892 |
| | | Adduct *3 | | | | |
| | Carboxylic | Alkenylsuccinic | 94.6 | 2680 | 20 | 398 |
| | acid | anhydride *4 | | | | |
| | component | Terephthalic | | | 80 | 1031 |
| | | acid | | | | |
| | Hydrocarbon- | Propylene | 0.4 | 13.5 | | |
| | based | tetramer *5 | | | | |
| | compound (i) | | | | | |

| Esterification | Tin(II) di(2-ethylhexanoate) *6 | 20 | 20 |
|---|---|---|---|
| catalyst | (charged amount g) | | |
| Content of hydrocarbon-based compound (i) *8 | | 0.34 | 0.00 |
| Total content of hydrocarbon-based compound | | 67.0 | 9.9 |
| (i) and alkenylsuccinic anhydride *9 | | | |
| Properties | Glass transition point Tg | −25.8 | 52.1 |
| | (° C.) | | |
| | Acid value (mgKOH/g) | 2 | 9 |
| | Hydroxyl value (mgKOH/g) | 14 | 12 |
| | Acid value + hydroxyl value | 16.0 | 21.0 |
| | (mgKOH/g) | | |
| | Number average molecular | 4800 | 4000 |
| | weight Mn | | |
| | Weight average molecular | 90000 | 19000 |
| | weight Mw | | |

| | | | Production Example | | | |
|---|---|---|---|---|---|---|
| | | | 9 | | 10 | |
| Kind of polyester resin-containing | | | C-2 | | C-3 | |
| composition or polyester resin | | | | | | |
| Raw material | Monomer composition | | Molar | Charged | Molar | Charged |
| monomer, etc. | | | ratio *7 | amount (g) | ratio *7 | amount (g) |
| | Alcohol | 1,2- | | | | |
| | component | Propanediol | | | | |
| | | Ethylene glycol | | | | |
| | | 1,4-Butanediol | | | | |
| | | 1,6-Hexanediol | 100 | 1712 | | |
| | | Propylene | | | | |
| | | glycol *1 | | | | |
| | | BPA-2PO | | | 25 | 679 |
| | | Adduct *2 | | | | |
| | | BPA-2EO | | | 75 | 1892 |
| | | Adduct *3 | | | | |
| | Carboxylic | Alkenylsuccinic | | | 20 | 398 |
| | acid | anhydride *4 | | | | |
| | component | Terephthalic | 95 | 2288 | 80 | 1031 |
| | | acid | | | | |
| | Hydrocarbon- | Propylene | | | 0.4 | 13.5 |
| | based | tetramer *5 | | | | |
| | compound (i) | | | | | |

| Esterification | Tin(II) di(2-ethylhexanoate) *6 | 20 | 20 |
|---|---|---|---|
| catalyst | (charged amount g) | | |

| Content of hydrocarbon-based compound (i) *8 | 0.00 | 0.33 |
|---|---|---|
| Total content of hydrocarbon-based compound | 0.0 | 10.2 |
| (i) and alkenylsuccinic anhydride *9 | | |

| | | | |
|---|---|---|---|
| Properties | Glass transition point Tg | 88.5 | 49.1 |
| | (° C.) | | |
| | Acid value (mgKOH/g) | 11 | 7 |
| | Hydroxyl value (mgKOH/g) | 21 | 9 |
| | Acid value + hydroxyl value | 32.0 | 16.0 |
| | (mgKOH/g) | | |
| | Number average molecular | 3500 | 4200 |
| | weight Mn | | |
| | Weight average molecular | 18000 | 21000 |

weight Mw

The blended components and notes in the table are as follows.
*1: Polypropylene glycol PPG-450I, available from Kao Specialties Americas, average molecular weight: 482
*2: Polyoxypropylene adduct of bisphenol A, average number of moles of PO added: 2.2 mol, molecular weight: 350
*3: Polyoxyethylene adduct of bisphenol A, average number of moles of EO added: 2.2 mol, molecular weight: 325
*4: Alkenylsuccinic acid, average molecular weight: 256, content of a compound with an alkenyl moiety having 12 carbon atoms: 70% or more and 85% or less
*5: Propylene tetramer, average molecular weight: 160 or more and 180 or less, content of a compound having 12 carbon atoms: 70% or more and 85% or less
*6: Tegokat 129 (available from TIB Chemicals)
*7: Moles relative to 100 moles of alcohol component (molar ratio)
*8: The content of the hydrocarbon-based compound (i) was determined by calculation as the ratio of the charged amount (g) of the hydrocarbon-based compound (i) to the total charged amount (g) of the alcohol component, carboxylic acid component, and hydrocarbon-based compound (i) [(charged amount of hydrocarbon-based compound (i))/(total charged amount of alcohol component, carboxylic acid component, and hydrocarbon-based compound (i))].
*9: The total content of hydrocarbon-based compound (i) + structural unit derived from alkenylsuccinic acid was calculated as the ratio of the total charged amount (g) of the hydrocarbon-based compound (i) and alkenylsuccinic acid anhydride to the total charged amount (g) of the alcohol component, carboxylic acid component, and hydrocarbon-based compound (i) [(total charged amount of hydrocarbon-based compound (i) and alkenylsuccinic acid anhydride)/(total charged amount of alcohol component, carboxylic acid component, and hydrocarbon-based compound (i))].

### Application Example 1

400 g of a straight asphalt (available from Associated Asphalt, Performance Grade (PG) 64-22) heated to 165° C. was measured into a 500 mL paint can, 20 g (5 parts by mass relative to 100 parts by mass of the asphalt) of the polyester resin-containing composition E-1 obtained in Production Example 1 was added thereto, a rid was put to prevent oxidation of the asphalt, the mixture was stirred at 165° C. and at a stirring speed of 400 rpm for 1 hour, thus preparing an asphalt composition AS-1.

Next, using the resulting asphalt composition AS-1, based on AASHTO R30-02, the aggregate as described below and the asphalt composition were mixed with a tabletop mixer (Hobart 5-Quart Mixer, available from Hobart) at 165° C. for 1 minute. Then, using a ventilated oven, the temperature was kept at 165° C. for 2 hours±5 minutes, thus preparing an asphalt mixture (hot mix asphalt). Specifically, the following formulation of aggregate was used, and the asphalt composition AS-1 was blended thereto so that the content of the straight asphalt in the hot mix asphalt was 5.6%, thus obtaining an asphalt mixture M-1.

### (Aggregate)

As the aggregate, an aggregate available from Blythe Construction, Inc was used. 2,600 g of the aggregate contained 650 g of ballast (coarse aggregate), 1,690 g of screenings (fine aggregate), and 260 g of pit sand (fine aggregate). The passing mass percentages of the components were as follows.

### Passing Mass Percentage:

### [Ballast]

Sieve mesh 9.50 mm: 90.4% by mass
Sieve mesh 8.00 mm: 73.3% by mass
Sieve mesh 4.75 mm: 24.8% by mass
Sieve mesh 2.80 mm: 3.9% by mass
Sieve mesh 1.00 mm: 1.2% by mass
Sieve mesh 0.50 mm: 0.8% by mass

### [Screenings]

Sieve mesh 9.50 mm: 100.0% by mass
Sieve mesh 8.00 mm: 99.9% by mass
Sieve mesh 4.75 mm: 98.2% by mass
Sieve mesh 2.80 mm: 77.4% by mass
Sieve mesh 1.00 mm: 36.8% by mass
Sieve mesh 0.50 mm: 22.1% by mass

### [Pit Sand]

Sieve mesh 9.50 mm: 100.0% by mass
Sieve mesh 8.00 mm: 100.0% by mass
Sieve mesh 4.75 mm: 98.0% by mass
Sieve mesh 2.80 mm: 94.2% by mass
Sieve mesh 1.00 mm: 70.6% by mass
Sieve mesh 0.50 mm: 33.6% by mass

### [Evaluation]

### [Evaluation of Peeling Resistance: Boiling Water Test]

The prepared asphalt mixture M-1 in a loosen state was cooled to 85° C. or higher and 95° C. or lower.

About 1000 mL of distilled water was put in a 2000 mL glass beaker, and was heated to 85° C. or higher using a heat source. About 250 g of the asphalt mixture M-1 was measured out and was added to boiling water in the glass beaker, and the mixture was kept for 10 minutes±15 seconds. The mass (g) of the weighed asphalt mixture M-1 for road pavement was taken as x.

Then, the glass beaker was taken away from the heat source, and free asphalt floating on the water surface was removed, and the asphalt mixture for road pavement in water was cooled to room temperature.

Water in the glass beaker was removed by decantation, then, 1000 mL of fresh cold water was added, and the mixture was allowed to stand for 10 minutes. Water in the glass beaker was removed by decantation again, and the asphalt mixture as a residue was taken out onto a paper towel and was dried by blowing with an electric fan for 24 hours.

The dried asphalt mixture was further subjected to 2 cycles of the operation of heating to 85° C. or higher and 95° C. or lower, keeping in boiling water, decantation, and drying. That is, the operation was performed three times in total. Note that the period of time of heating to 85° C. or higher and 95° C. or lower was limited within 1 hour for preventing oxidation of the asphalt.

After the last drying for 24 hours, the mass of the asphalt mixture M-1 for road pavement was measured. The mass (g) of the asphalt mixture M-1 for road pavement after drying for 24 hours was taken as y.

According to the following equation (1), the mass loss (%) was calculated to evaluate the peeling resistance of the asphalt composition. A smaller mass loss (%) is evaluated as a higher peeling resistance.

$$mass loss ( \% ) = 100 \times ( x - y ) / x \qquad Equation ( 1 )$$

The results are shown in Table 2.

### [Evaluation of Rutting Resistance: Hamburg Wheel Tracking Testing]

Based on AASHTO T 324, the Hamburg wheel tracking testing was performed to evaluate the rutting resistance.

Using the prepared asphalt mixture M-1, at 165° C., with a gyratory compactor (G2 Gyratory Compactor, available from Pine Test Equipment), four asphalt specimens each having a diameter of 150 mm, a height of 60 mm, and a porosity of 7.0±1.0% by mass were produced.

Based on AASHTO T 324, an edge of each specimen was cut so that the gap between two specimens was 7.5 mm, and the specimens were set in a mold. Using a wheel tracking tester, the asphalt specimens were immersed in water at a temperature of 50° C., and the maximum quantity of rutting was measured after allowing a wheel to run 20,000 times under a load of 705±4.5N.

The maximum quantity of rutting in the wheel tracking testing is a measure of the rutting resistance of asphalt pavement, namely, the durability, and a smaller maximum quantity of rutting is evaluated as a higher durability.

The results are shown in Table 2.

### Application Examples 2 to 4

Asphalt mixtures were obtained in the same manner as in Application Example 1 except for changing the amount of the polyester resin composition E-1 blended in Application Example 1 to 8 g (2 parts by mass relative to 100 parts by mass of the asphalt), 40 g (10 parts by mass relative to 100 parts by mass of the asphalt), and 80 g (20 parts by mass relative to 100 parts by mass of the asphalt), respectively. In the same manner as in Application Example 1, the mass loss (%) in the boiling water test and the maximum quantity of rutting in the Hamburg wheel tracking testing were measured. The results are shown in Table 2.

### Examples 5 to 10, Comparative Application Examples 2 to 4

Asphalt mixtures were obtained in the same manner as in Application Example 1 except for changing the polyester resin composition E-1 in Application Example 1 to the polyester resin compositions or polyester resins E-2 to E-7, C-1 to C-3 obtained in Production Examples 2 to 10, respectively. In the same manner as in Application Example 1, the mass loss (%) in the boiling water test and the maximum quantity of rutting in the Hamburg wheel tracking testing were measured. The results are shown in Table 2.

### Application Example 11

An asphalt mixture was obtained in the same manner as in Application Example 1 except for using a combination of 20 g of the polyester resin composition E-1 and 20 g of the polyester resin C-1 (5 parts by mass each relative to 100 parts by mass of the asphalt) in place of 20 g of the polyester resin-containing composition E-1 in Application Example 1. In the same manner as in Application Example 1, the mass loss (%) in the boiling water test and the maximum quantity of rutting in the Hamburg wheel tracking testing were measured. The results are shown in Table 2.

### Comparative Example 1

An asphalt mixture was obtained in the same manner as in Application Example 1 except for not blending the polyester resin composition E-1. The mass loss (%) in the boiling water test and the maximum quantity of rutting in the Hamburg wheel tracking testing were measured. The results are shown in Table 2

TABLE 2

| | | | Polyester resin- | | | |
|---|---|---|---|---|---|---|
| | | | containing composition | | Evaluation | |
| | | | or polyester resin | | | Maximum |
| | | | | Content | Mass | quantity |
| | Asphalt | Asphalt | | (parts by | loss | of rutting |
| | composition | Kind | Kind | mass) *1 | (%) | (mm) |
| Application Example 1 | AS-1 | Straight | E-1 | 5 | 99.2 | 2.5 |
| | | asphalt | | | | |
| Application Example 2 | AS-2 | Straight | E-1 | 2 | 97.8 | 3.7 |
| | | asphalt | | | | |
| Application Example 3 | AS-3 | Straight | E-1 | 10 | 99.3 | 4.0 |
| | | asphalt | | | | |
| Application Example 4 | AS-4 | Straight | E-1 | 20 | 99.5 | 6.1 |
| | | asphalt | | | | |
| Application Example 5 | AS-5 | Straight | E-2 | 5 | 99.1 | 2.1 |
| | | asphalt | | | | |
| Application Example 6 | AS-6 | Straight | E-3 | 5 | 99.0 | 1.4 |
| | | asphalt | | | | |
| Application Example 7 | AS-7 | Straight | E-4 | 5 | 99.0 | 1.7 |
| | | asphalt | | | | |
| Application Example 8 | AS-8 | Straight | E-5 | 5 | 99.6 | 3.9 |
| | | asphalt | | | | |
| Application Example 9 | AS-9 | Straight | E-6 | 5 | 96.5 | 2.8 |
| | | asphalt | | | | |
| Application Example 10 | AS-10 | Straight | E-7 | 5 | 97.2 | 2.0 |
| | | asphalt | | | | |
| Application Example 11 | AS-11 | Straight | E-1 + | 5 + 5 | 99.5 | 1.5 |
| | | asphalt | C-1 | | | |
| Comparative Example 1 | AS-C0 | Straight | — | 0 | 93.8 | 8.0 |
| | | asphalt | | | | |
| Comparative Example 2 | AS-C1 | Straight | C-1 | 5 | 94.6 | 1.3 |
| | | asphalt | | | | |
| Comparative Example 2 | AS-C1 | Straight | C-2 | 5 | 95.5 | 1.4 |
| | | asphalt | | | | |
| Comparative Example 3 | AS-C2 | Straight | C-3 | 5 | 95.1 | 3.1 |
| | | asphalt | | | | |

Note in the table is as follows.
*1: Content relative to 100 parts by mass of asphalt (parts by mass)

It is found from Table 2 that the asphalt compositions of Application Examples 1 to 11 in each of which a specific polyester resin composition was used each provide an asphalt specimen exhibiting a peeling resistance superior to those of the asphalt compositions of Comparative Examples.

1. An asphalt composition comprising an asphalt and a polyester resin composition, wherein
the polyester resin composition comprises a polyester resin and a hydrocarbon-based compound (i),
the polyester resin has a structural unit derived from an alcohol component and a structural unit derived from a carboxylic acid component, wherein the carboxylic acid component contains at least one succinic acid compound selected from the group consisting of an alkylsuccinic acid and an alkenylsuccinic acid,
the polyester resin composition has a glass transition point between −70° C. and 30° C.,
the polyester resin composition is present in an amount of ≥0.5 parts by mass and ≤25 parts by mass relative to 100 parts by mass of the asphalt.

2. The asphalt composition according to claim 1, wherein the succinic acid compound is at least one succinic acid compound selected from the group consisting of an alkylsuccinic acid having an alkyl group having 9 or more and 19 or less carbon atoms and an alkenylsuccinic acid having an alkenyl group having 9 or more and 19 or less carbon atoms.

3. The asphalt composition according to claim 1, wherein the polyester resin composition has a content of the hydrocarbon compound (i) of ≥0.1% by mass and ≤0.5% by mass.

4. The asphalt composition according to claim 1, wherein the hydrocarbon-based compound (i) comprises a hydrocarbon-based compound (i) having ≥9 and ≤18 carbon atoms and wherein the asphalt composition is for road pavement.

5. The asphalt composition according to claim 1, wherein the polyester resin is a polyester resin having a weight average molecular weight of ≥2,000 and ≤100,000.

6. An asphalt modifier comprising a polyester resin and a hydrocarbon-based compound (i), wherein
the polyester resin has a structural unit derived from an alcohol component and a structural unit derived from a carboxylic acid component, wherein the carboxylic acid component contains at least one succinic acid compound selected from the group consisting of an alkylsuccinic acid and an alkenylsuccinic acid, and
the asphalt modifier has a glass transition point between −70° C. and 30° C.

7. The asphalt composition according to claim 1, wherein the hydrocarbon compound (i) is at least one compound selected from the group consisting of an alkane which is a saturated hydrocarbon compound and an alkene which is an unsaturated hydrocarbon compound.

8. The asphalt composition according to claim 1, wherein the hydrocarbon compound (i) is a compound derived from ethylene, propylene, isobutylene, or n-butylene, and is a trimer or tetramer thereof.

9. The asphalt composition according to claim 1, wherein the hydrocarbon compound (i) has a number average molecular weight of from 100 to 300.

10. The asphalt composition according to claim 1, wherein a content of the polyester resin is from 99.5% by mass to 99.9% by mass in 100% by mass of the polyester resin composition.

11. The asphalt composition according to claim 1, wherein an acid value of the polyester resin composition is from 0 mgKOH/g to 20 mgKOH/g.

12. The asphalt composition according to claim 1, wherein the polyester resin composition is obtained by, in the presence of the hydrocarbon compound (i), subjecting the alcohol component and the carboxylic acid component to a polycondensation reaction to obtain the polyester resin.

13. A method for producing an asphalt composition, comprising:
in the presence of a hydrocarbon compound (i), subjecting an alcohol component and a carboxylic acid component to a polycondensation reaction to obtain a polyester resin composition, wherein the carboxylic acid component contains at least one succinic acid compound selected from the group consisting of an alkylsuccinic acid and an alkenylsuccinic acid; and
mixing an asphalt and the polyester resin composition.

14. The method according to claim 13, wherein the mixing is performed at a temperature of from 140° C. to 190° C.

15. An asphalt mixture containing at least an aggregate and the asphalt composition according to claim 1.

16. The asphalt mixture according to claim 15, wherein a content of the aggregate is from 85% by mass to 98% by mass in 100% by mass of the asphalt mixture.

17. A method for producing an asphalt mixture, comprising:
mixing an aggregate and the asphalt composition according to claim 1 at a temperature of from 130° C. to 230° C.

18. A road pavement method comprising:
mixing the asphalt composition according to claim 1 and a heated aggregate to obtain an asphalt mixture; and
laying down the asphalt mixture obtained by the mixing on a road to form an asphalt pavement material layer.
